(19) United States
(12) Patent Application Publication
(10) Pub. No.: US 2013/0215361 A1
(43) Pub. Date: Aug. 22, 2013

(54) Light Guide Plate, Backlight Module and LCD Device

(71) Applicant: Yewen Wang, Shenzhen (CN)

(72) Inventor: Yewen Wang, Shenzhen (CN)

(21) Appl. No.: 13/503,951

(22) PCT Filed: Feb. 27, 2012
(86) PCT No.: PCT/CN12/71653

§ 371 Date: Apr. 25, 2012

(30) Foreign Application Priority Data
Feb. 16, 2012 (CN) 201210034831.1

(51) Int. Cl. G02F 1/13357; F21V 8/00

(52) U.S. Cl. 349/62; 362/615; 362/611; 362/612

(57) ABSTRACT

The invention discloses a light guide plate, a backlight module and an LCD device; the light incident surface of the light guide plate is coated with a layer of fluorescent powder. In the invention, because the light incident surface of the light guide plate is coated with a layer of fluorescent powder, it is not necessary to add the fluorescent powder coating process in the primary color light source, such as the LED package to generate white light; the nonwhite light beams of the primary color light source are changed into white light through the fluorescent powder layer before entering the inside of the light guide plate, so as to guarantee the color requirement of light, and enable the fluorescent powder to be away from the LED chips; thus, the light decline occurrence because the fluorescent powder is heated by the heat generated by the light source, such as heat generated by the LED chips is avoided, the reduction of the light emitting efficiency of the light source because of the change of the fluorescent powder is avoided, and then the luminous intensity of the backlight module and the display effect of the LCD device are increased.

### TECHNICAL FIELD

The invention relates to the field of liquid crystal displays (LCDs), and more particularly to a light guide plate, a backlight module and an LCD device.

### BACKGROUND

In recent years, because of the advantages of small volume, light weight, small thickness, and low consumption, LCDs are greatly developed. Because an LCD device is a passive electronic display device, a backlight module is required to provide a light source; the backlight module is divided into a direct-light backlight module and an edge-light backlight module in accordance with the incident light mode. The light source of the edge-light backlight module comprises a light guide plate and a light bar arranged on the side of the light guide plate; the light bar is provided with a plurality of white light emitting diodes (WLEDs); in addition, cold cathode fluorescent lamps (CCFLs) can also be used as the light source of the backlight module; relatively, WLEDs are more environmentally friendly, have higher efficiency, and are mainly used as a light source at present.

However, in the process of using the WLEDs of the backlight, because fluorescent powder is easily heated by the heat generated by the light emitting diode chips (LED chips) to cause light decline, the light emitting efficiency is obviously reduced, and the luminous intensity of the backlight module is affected.

### SUMMARY

In view of the above-described problems, one aim of the invention is to provide a light guide plate capable of increasing the display effect of LCD devices, a backlight module, and an LCD device.

The purpose of the invention is achieved by the following technical schemes.

A light guide plate, the light incident surface of the light guide plate is coated with a layer of fluorescent powder.

Preferably, the light incident surface of the light guide plate is provided with multiple convex surface structures arranged side by side. The convex surface structures can reduce the refraction concentration rate of the incident light in the light guide plate, thereby increasing the light uniformity of the light guide plate; and the convex surface structures can make the light emitted by the chips arrive at the fluorescent powder layer at the same light path, thereby reducing the occurrence degree of color cast, and avoiding the light interference among LEDs, to enable the mixed light among the LEDs to become uniform.

Preferably, the light incident surface of the light guide plate is provided with multiple concave surface structures arranged side by side. Cylindrical surface structures can reduce the refraction concentration rate of the incident light in the light guide plate, thereby increasing the light uniformity of the light guide plate; and the cylindrical surface structures can make the light emitted by the chips arrive at the fluorescent powder layer at the same light path, thereby reducing occurrence degree of color cast, and avoiding the light interference among LEDs, to enable the mixed light among the LEDs become uniform.

Preferably, the light guide plate further comprises a body of the light guide plate and a bearing film arranged on the light incident surface of the body of the light guide plate; the fluorescent powder is coated on the bearing film. The fluorescent powder is coated on the bearing film, and then the bearing film is attached to the light guide plate, facilitating processing, and increasing production efficiency.

Preferably, one side of the bearing film is provided with multiple cylindrical surface structures arranged side by side, and the fluorescent powder is coated on the side with multiple convex surface structures arranged side by side. It is more convenient to form the convex surface structures on the bearing film than to form the cylindrical surface structures on the light guide plate.

Preferably, one side of the bearing film is provided with multiple concave surface structures arranged side by side, and the fluorescent powder is coated on the side with multiple concave surface structures arranged side by side. It is more convenient to form the concave surface structures on the bearing film than to form the concave surface structures on the light guide plate.

A backlight module comprises a primary color light source and the aforementioned light guide plate.

Preferably, blue LEDs are used as the primary color light source. The blue LEDs are LEDs with the advantages of high quality, easy manufacture and low cost.

An LCD device comprises the aforementioned backlight module.

Preferably, the primary color LEDs are blue LEDs. The blue LEDs are LEDs with the advantages of high quality, easy manufacture and low cost.

In the invention, because the light incident surface of the light guide plate is coated with a layer of fluorescent powder, it is not necessary to add the fluorescent powder coating process in the primary color light source such as LEDs package to generate white light; nonwhite light beams of the primary color light source are changed into white light through the fluorescent powder layer before entering the inside of the light guide plate, so as to guarantee the color requirement of light, and enable the fluorescent powder to be away from the LED chips; thus, the light decline occurrence because the fluorescent powder is heated by the heat generated by the light source, such as the heat generated by the LED chips is avoided, the reduction of the light emitting efficiency of the light source because of the change of the fluorescent powder is avoided, and then the luminous intensity of the backlight module and the display effect of the LCD device are increased.

### BRIEF DESCRIPTION OF FIGURES

FIG. 1 is a simplified diagram of a light guide plate and a light bar of a backlight module of example 1 of the invention;

FIG. 2 is an enlarged view of A shown in FIG. 1;

FIG. 3 is a simplified diagram of a light guide plate and a light bar of a backlight module of example 2 of the invention;

FIG. 4 is an enlarged view of B shown in FIG. 3;

FIG. 5 is a simplified diagram of a light guide plate and a light bar of a backlight module of example 3 of the invention; and

FIG. 6 is a simplified diagram of a light guide plate and a light bar of a backlight module of example 4 of the invention.

Wherein: 10. LED; 20. light guide plate; 21. bearing film; 22. fluorescent powder.

### DETAILED DESCRIPTION

The invention will further be described in detail in accordance with the figures and the preferable examples.

### Example 1

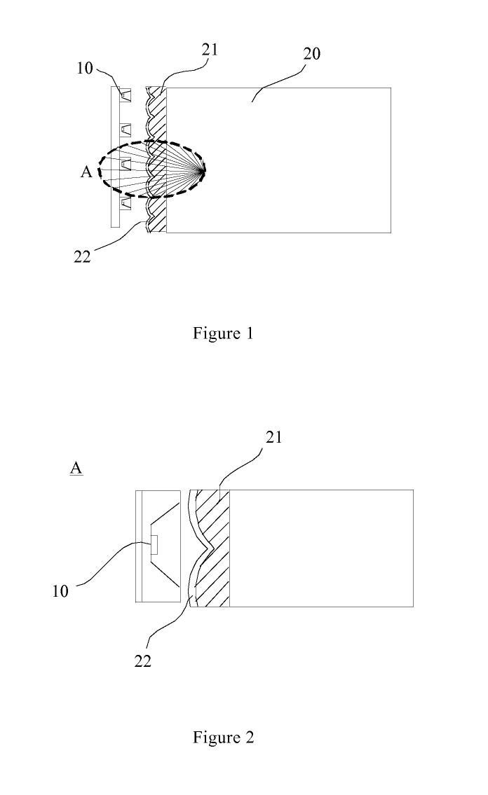

Example 1 of the invention is shown in FIG. 1 and FIG. 2; a backlight module comprises a light guide plate 20, LEDs 10 and the like; the LEDs 10 are primary color LEDs without being coated with fluorescent powder in the package; in the example, blue LEDs are used as the light source of the backlight module, and other light sources such as CCFLs and the like can be used as well; the light emitted by the blue LEDs is blue light rather than white light; the light incident surface of the body of the light guide plate 20 is provided with a layer of fluorescent powder 22 for changing the blue light emitted by LEDs 10 into white light, so as to enter the inside of the light guide plate. Thus, the fluorescent powder is away from the LED chips; therefore, the light decline occurrence because the fluorescent powder is heated by the heat generated by the LED chips is avoided, the reduction of the light emitting efficiency of the LEDs because of the change of the fluorescent powder is avoided, and then the luminous intensity of the backlight module and the display effect of the LCD device are increased.

In the example 1, the fluorescent powder 22 is coated on a bearing film 21, and then the bearing film 21 is attached to the light incident surface of the light guide plate 20. The surface of one side (coated with fluorescent powder 22) of the bearing film 21 facing the LEDs 10 is provided with multiple convex surface structures arranged side by side, and the other side is a flat surface; the flat surface is attached to the light incident surface of the body of the light guide plate, and correspondingly, the light incident surface of the body of the light guide plate should be a flat surface. The convex surface structures on the bearing film 21 can reduce the refraction concentration rate of the incident light in the light guide plate 20, thereby increasing the light uniformity of the light guide plate; and the convex surface structures can make the light emitted by the LEDs 10 arrive at the fluorescent powder layer at the same light path, thereby reducing the occurrence degree of color cast. In addition, because of the existence of the cylindrical surface structures, the incident angle of light is changed, and then the hotspot generated by light interference among LEDs is avoided, to enable the mixed light among the LEDs to become uniform.

### Example 2

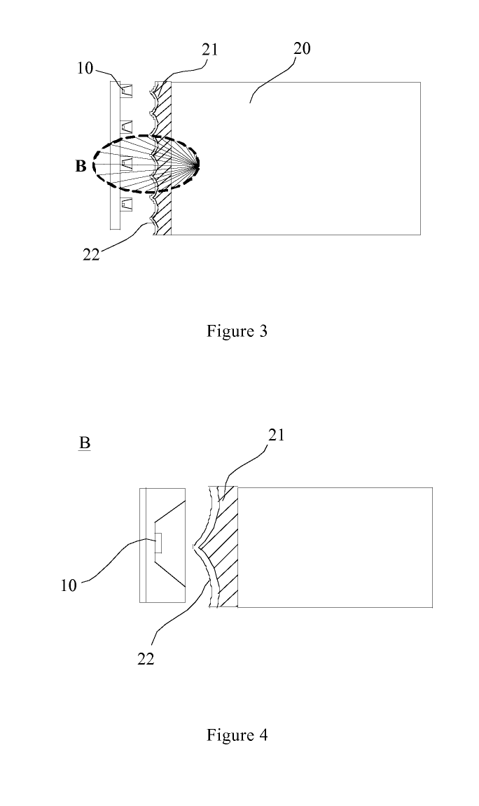

Example 2 of the invention is shown in FIG. 3 and FIG. 4, and example 2 is different from example 1 in that: one side of the bearing film 21 coated with the fluorescent powder 22 is provided with multiple concave surface structures arranged side by side; the concave surface structures can reduce the refraction concentration rate of the incident light in the light guide plate 20, thereby increasing the light uniformity of the light guide plate; and the concave surface structures can make the light emitted by the LEDs 10 arrive at the fluorescent powder layer at the same light path, thereby reducing the occurrence degree of color cast In addition, because of the existence of the cylindrical surface structures, the incident angle of light is changed, and then the hotspot generated by light interference among LEDs is avoided, to enable the mixed light among the LEDs to become uniform.

In the invention, because the fluorescent powder is coated on the light guide plate, it is not necessary to coat the fluorescent powder on the package of the LEDs of the light bar, so that the LED package process is simplified.

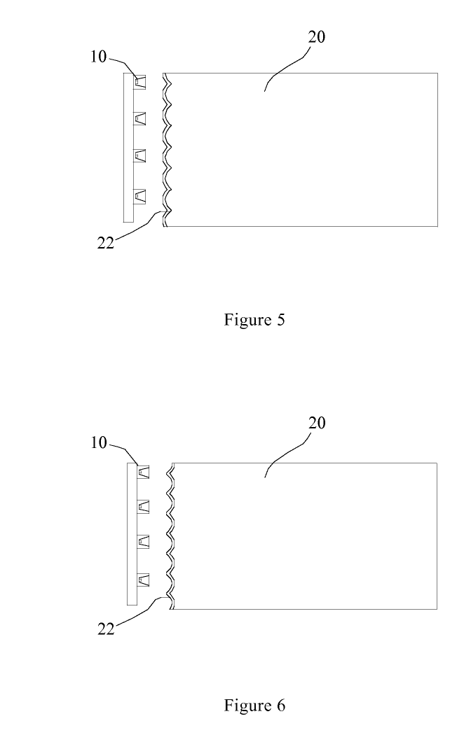

In the invention, FIG. 5 and FIG. 6 respectively show example 3 and example 4 of the invention; as shown in the figure, the fluorescent powder 22 can be directly coated on the light incident surface of the light guide plate 20 without being coated on the bearing film. Likewise, the convex surface structures and the concave surface structures can be directly processed and formed on the light incident surface of the body of the light guide plate 20; however, as the light guide plate is difficult to process because of material characteristics and thin thickness of the light guide, arranging the convex and concave surface structures on the bearing film facilitates the process of processing.

Because the light incident surface of the light guide plate of the invention is formed with the convex and concave surface structures, high-lumen LEDs can be used on the light bar, and no nonuniform light can be generated.

Optionally, the convex and concave surface structures of the two examples of the invention can have various forms, for example, the convex surface structures in example 1 can be multiple convex cylindrical surfaces arranged side by side on the body of the light guide plate, and can be multiple convex spherical surfaces arranged side by side on the body of the light guide plate as well; in example 2, the concave surface structures can be multiple hole surfaces arranged side by side with equal diameter on the body of the light guide plate, and can be multiple concave spherical surfaces arranged side by side on the body of the light guide plate as well.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. A light guide plate, the light incident surface of said light guide plate is coated with a layer of fluorescent powder.

2. The light guide plate of claim 1, wherein the light incident surface of said light guide plate is provided with multiple convex surface structures arranged side by side.

3. The light guide plate of claim 1, wherein the light incident surface of said light guide plate is provided with multiple concave surface structures arranged side by side.

4. The light guide plate of claim 1, wherein said light guide plate further comprises a body of the light guide plate and a bearing film arranged on the light incident surface of the body of said light guide plate; said fluorescent powder is coated on said bearing film.

5. The light guide plate of claim 4, wherein one side of said bearing film is provided with multiple convex surface structures arranged side by side, and said fluorescent powder is coated on said side with multiple cylindrical surface structures arranged side by side.

6. The light guide plate of claim 4, wherein one side of said bearing film is provided with multiple concave surface structures arranged side by side, and said fluorescent powder is coated on said side with multiple concave surface structures arranged side by side.

7. A backlight module, comprising: a primary color light source and a light guide plate; the light incident surface of said light guide plate is coated with a layer of fluorescent powder.

8. The backlight module of claim 7, wherein the light incident surface of said light guide plate is provided with multiple convex surface structures arranged side by side.

9. The backlight module of claim 7, wherein the light incident surface of said light guide plate is provided with multiple concave surface structures arranged side by side.

10. The backlight module of claim 7, wherein said light guide plate further comprises a body of the light guide plate and a bearing film arranged on the light incident surface of the body of the light guide plate; said fluorescent powder is coated on said bearing film.

11. The backlight module of claim 10, wherein one side of said bearing film is provided with multiple convex surface structures arranged side by side, and said fluorescent powder is coated on said side with multiple cylindrical surface structures arranged side by side.

12. The backlight module of claim 10, wherein one side of said bearing film is provided with multiple concave surface structures arranged side by side, and said fluorescent powder is coated on said side with multiple concave surface structures arranged side by side.

13. The backlight module of claim 7, wherein the blue LEDs are used as said primary color light source.

14. An LCD device, comprising: a backlight module; said backlight module comprises a light guide plate, and the light incident surface of said light guide plate is coated with a layer of fluorescent powder.

15. The LCD device of claim 14, wherein the light incident surface of said light guide plate is provided with multiple convex surface structures arranged side by side.

16. The LCD device of claim 14, wherein the light incident surface of said light guide plate is provided with multiple concave surface structures arranged side by side.

17. The LCD device of claim 14, wherein said light guide plate further comprises a body of the light guide plate and a bearing film arranged on the light incident surface of the body of the light guide plate; said fluorescent powder is coated on said bearing film.

18. The LCD device of claim 17, wherein one side of said bearing film is provided with multiple convex surface structures arranged side by side, and said fluorescent powder is coated on said side with multiple cylindrical surface structures arranged side by side.

19. The LCD device of claim 17, wherein one side of said bearing film is provided with multiple concave surface structures arranged side by side, and said fluorescent powder is coated on said side with multiple concave surface structures arranged side by side.
